(19) United States
(12) Patent Application Publication
(10) Pub. No.: US 2016/0376749 A1
(43) Pub. Date: Dec. 29, 2016

(54) METHOD FOR PRODUCING NANOFIBRILLATED CELLULOSE

(71) Applicant: KOREA INSTITUTE OF INDUSTRIAL TECHNOLOGY, Cheonan-si, Chungcheongnam-do (KR)

(72) Inventors: Dae Young Lim, Yongin-si (KR); Ki Young Kim, Yongin-si (KR); Jin Ah Lee, Ansan-si (KR)

(73) Assignee: Korea Institute of Industrial Technology, Chungcheongnam-do (KR)

(21) Appl. No.: 15/039,722

(22) PCT Filed: Dec. 19, 2013
(86) PCT No.: PCT/KR2013/011874

§ 371 Date: May 26, 2016

(30) Foreign Application Priority Data
Nov. 26, 2013 (KR) 10-2013-0144890

(51) Int. Cl. D21C 3/02; D21C 9/00; C08B 15/00

(52) U.S. Cl. CPC D21C 3/024; C08B 15/00; D21C 9/007; D21C 9/002

(57) ABSTRACT

The present invention relates to a method for preparing nanofibrillated cellulose capable of producing high-quality cellulose nanofibrils by a simple process without using the conventional enzymatic treatment, in which a cellulose aqueous dispersion is homogenized by adding an aqueous alkaline solution having a pH between 8 and 14 thereto so that the aqueous alkaline solution aids the swell of an amorphous region of cellulose, thereby promoting the nanofibrillation of cellulose during the homogenizing process.

### TECHNICAL FIELD

The present invention relates to a method for preparing nanofibrillated cellulose capable of producing high-quality cellulose nanofibrils by a simple process without using conventional enzymatic treatment, in which a cellulose aqueous dispersion is homogenized by adding an aqueous alkaline solution having a pH between 8 and 14 thereto so that the aqueous alkaline solution aids the swell of an amorphous region of cellulose, thereby promoting the nanofibrillation of cellulose during the homogenizing process.

### BACKGROUND ART

Cellulose is the most general natural polymer having a basic unit of β-1,4-glucose, which is the most abundant and renewable resource among all organic compounds present in nature, and is used in the form of pulp, building materials, energy sources, etc. Recently, with a growing demand on the environment-friendly polymer materials, study has been focused on highly-purified cellulose from the bacterial cellulose or wood to replace various kinds of functional polymers from petrochemicals (G. Siqueira et al., Polymer, 2010, 2, 728-765).

In particular, intensive studies have been performed on the separation of cellulose microfibrils from plants to use the cellulose microfibrils as a reinforcing material for nanofiber composite materials (M. Paakko et al., Biomacromolecules, 2007, 8, 1934-1941).

Nanofibrillated cellulose is known to have high elasticity of 150 GPa to 200 GPa and high strength of 5 GPa or higher, and these physical properties of nanofibrillated cellulose are excellent compared to those of general carbon fiber and glass fiber. Additionally, nanofibrillated cellulose has the merits of a low mean size, low expansion coefficient, environment-friendliness, recyclability, etc., and there is a large possibility that nanofibrillated cellulose can replace glass fiber in the composite material industry if the nanofibrillation of cellulose can be achieved by optimization of its preparation process (T. Zimmermann et al., Advanced Engineering Materials, 2004, 6, 754-761).

In this regard, intensive studies have been performed on natural fiber materials in England, Germany, USA, Japan, etc., and in particular, Innventia (Sweden) had previously reported their research result on the preparation of cellulose nanofibers by hydrolytic decomposition comprising enzymatic treatment and mechanical treatment (M. Paakko et al., Biomacromolecules, 2007, 8, 1934-1941). However, research and development on the nanofibrillation of cellulose and its application on composite materials is still in its early stages.

Microfibrils with a mean size of 100 nm or less are mainly prepared by mechanical homogenization such as refining or homogenizing in an aqueous dispersion. Homogenization is a method to make a mixture homogeneous by dispersing each component in a non-homogeneous mixture into fine particles, and methods of homogenization can be classified into mechanical treatments and chemical treatments. The structure and shape of cellulose fibers can vary according to the method of homogenization, i.e., mechanical or chemical treatment. In particular, cellulose may be fibrillated by impact force, shearing force, and cavitation which occur when an aqueous dispersion of cellulose is passed through a micro nozzle under high pressure, and repetition of the process (J. Floury et al., Innovative Food Science and Emerging Technologies, 2000, 1, 127 -134). The level of fibrillation can be partially controlled by the regulation of the number of passes through a high pressure homogenizer.

However, the nanofibrillation of cellulose does not progress continuously with the increase in the number of passes of the homogenizer, and there is a disadvantage such as a decrease in crystallinity after repeated mechanical treatment, thus requiring the optimization of the preparation process to minimize this disadvantage.

Alkali treatment of cellulose is mainly processed using aqueous ammonia solution and sodium hydroxide (A. N. Nakagaito et al., Cellulose, 2008, 15, 323-331). When cellulose is immersed into an aqueous alkaline solution, cellulose becomes constricted in a width direction and swollen in a height direction. Such aqueous ammonia solution have been mainly used as a swelling agent of cellulose in the conventional biomass conversion process (T. T. T. Ho et al., Journal of Polymer Science Part B: Polymer Physics, 2013, 51, 638-648). The ammonia molecules used as a swelling agent penetrate into the inside of cellulose and replace the hydrogen bond (O—H . . . O) between cellulose molecules, which are interconnected between cellulose and ammonia, with the hydrogen bond (O—H . . . N) between cellulose and ammonia molecules. The bond (O—H . . . N) is disassembled during the washing process. Natural cellulose has the structure of cellulose I, but, after ammonia treatment, the structure of cellulose changes into the structure of cellulose III. In the basic structure, the cellulose III has larger volume, longer molecular chain distance, and lower density compared to cellulose I.

Accordingly, the present inventors have developed a technology to promote nanofibrillation through a simple process by inducing the swelling of the cellulose molecular chains in the high pressure homogenizer utilizing the conventional biomass conversion process by adding an aqueous alkaline solution having a pH between 8 and 14, and confirmed that an aqueous alkaline solution can help the nanofibrillation of cellulose, by comparing the crystalline properties, mean size, specific surface area, and morphological structure with those of the cellulose nanofibrils prepared in the conventional aqueous dispersion state, thereby completing the present invention.

### SUMMARY OF THE INVENTION

An object of the present invention is to provide a method for preparing high-quality cellulose nanofibrils by a simple process without going through with enzymatic treatment.

In order to achieve the above object, the present invention provides a method for preparing nanofibrillated cellulose, including:

dispersing pulp in water to obtain an aqueous dispersion of pulp (Step 1);

adding an aqueous alkaline solution having a pH between 8 and 14 to the aqueous dispersion of pulp to obtain a dispersed aqueous alkaline solution of pulp (Step 2); and

homogenizing the dispersed aqueous alkaline solution of pulp to obtain a homogenized material (Step 3).

Preferably, the method for preparing nanofibrillated cellulose may further include mechanically refining the aqueous dispersion of pulp after Step 1.

Preferably, the method for preparing nanofibrillated cellulose may further include stirring the dispersed aqueous alkaline solution of pulp after Step 2 (Step 2-1).

Preferably, the method for preparing nanofibrillated cellulose may further include drying the homogenized material after Step 3 (Step 3-1).

Cellulose fibrillation has been conventionally prepared by a mechanical method such as refining or homogenizing in a state of an aqueous dispersion. Additionally, the structure and shape of cellulose fibers could have been controlled by a chemical method such as an enzymatic treatment accompanying the mechanical method. In particular, in the case of using a high pressure homogenizer, the cellulose can be fibrillated by repeating the process of passing the cellulose through a micro nozzle under high pressure, and the level of fibrillation can be controlled partially by repeating the passes through the high pressure homogenizer and adjusting the size of the micro nozzle. However, the above mechanical method has problems in that the method cannot achieve a satisfiable degree of cellulose fibrillation, and also is not efficient with respect to the obtainment of fibrillated cellulose with a mean size of a certain level which requires an increasing number of passes through the homogenizer under high pressure. The enzymatic treatment method also has disadvantages of long processing time and high cost.

The present invention provides a method for preparing fibrillated cellulose at a nano level via homogenization after adding an aqueous alkaline solution to a cellulose aqueous dispersion.

The method for nanofibrillation of the present invention is a method for preparing high-quality cellulose nanofibrils by a simple process without using the conventional enzymatic treatment, in which an aqueous alkaline solution aids the swell of an amorphous region of cellulose, thereby promoting the nanofibrillation of cellulose during the homogenizing process.

The present invention will be explained in detail herein below.

Step 1 relates to preparing an aqueous dispersion of pulp by dispersing pulp in water.

In the present invention, the pulp in Step 1 may be wood pulp such as hardwood pulp, softwood pulp, etc., but is not limited thereto.

Step 1-1 relates to mechanical refining of the aqueous dispersion of pulp obtained in Step 1, thereby further dispersing and dissociating the pulp in water.

In the present invention, the mechanical refining may be performed using the pulper for the wet-laid nonwoven equipment. Additionally, the mechanical refining may be preferably performed for 20 minutes to 1 hour. By performing the mechanical refining, pulp can be sufficiently dissociated in an efficient manner during the period of the mechanical refining.

Step 2 relates to adding an aqueous alkaline solution having a pH between 8 and 14 to the aqueous dispersion of pulp to obtain a dispersed aqueous alkaline solution of pulp, in which pulp is dispersed in the aqueous alkaline solution. Preferably, the aqueous alkaline solution having a pH between 8 and 14 is aqueous ammonia solution.

The preparation method of the present invention has an effect of promoting nanofibrillation via homogenization by adding an aqueous alkaline solution having a pH between 8 and 14 to an aqueous dispersion of pulp as described above.

Specifically, in an exemplary embodiment of the present invention, nanofibrillated cellulose was prepared via homogenization in the state of an aqueous dispersion of pulp or dispersed aqueous ammonia solution of pulp, respectively, and the mean size of the as-prepared nanofibrillated cellulose was examined. As a result, when an aqueous ammonia solution dispersion was used, nanofibrillated cellulose with a smaller mean size was obtained compared to the case of aqueous dispersion, thus confirming that the use of aqueous ammonia solution can promote nanofibrillation (Experimental Example 2).

In the present invention, the aqueous dispersion of pulp in Step 2 may preferably contain pulp solid in a concentration of from 0.01 wt % to 1 wt %. In Step 2, the use of a low-concentration aqueous dispersion, which contains the pulp solid in a low concentration of from 0.01 wt % to 1 wt %, can facilitate the dissociation of pulp.

In the present invention, the amount of the aqueous alkaline solution having a pH between 8 and 14 in Step 2 may be in an amount of 0.1 vol % to 20 vol % relative to that of the aqueous dispersion of pulp. When the addition of the aqueous alkaline solution is less than 0.1 vol %, the degree of nanofibrillation becomes low, thus increasing the mean size of the nanofibrils of cellulose, whereas when the addition of the aqueous alkaline solution exceeds 20 vol %, excessive nanofibrillation can occur and the cellulose nanofibrils become aggregated with adjacent nanofibrils, thereby increasing the mean size of the cellulose nanofibrils.

Step 2-1 relates to stirring the dispersed aqueous alkaline solution of pulp after Step 2 thereby further homogenously dispersing the pulp in the aqueous alkaline solution.

In the present invention, the stirring may be preferably performed for from 20 minutes to 1 hour. By stirring for the described time period, sufficient stirring can be advantageously performed in an efficient manner.

Step 3 relates to homogenizing the dispersed aqueous alkaline solution of pulp to obtain nanofibrillated cellulose.

In the present invention, the homogenization of Step 3 may be performed by passing the dispersed aqueous alkaline solution of pulp through a homogenizer. In particular, a high pressure homogenizer such as a microfluidizer may be used for the homogenization. Specifically, the use of a z-shaped chamber can maximize the fibrillation efficiency and thus it is preferable to use the z-shaped chamber.

In the present invention, the internal pressure of the homogenizer may be in the range from 70 MPa to 310 MPa. When the internal pressure of the homogenizer is within the above range, the fibrillation can be advantageously performed in an easy and efficient manner.

In the present invention, the diameter of the nozzle may be in the range from 50 μm to 250 μm. When the nozzle diameter is smaller than 50 μm, the pressure becomes too great when the dispersed aqueous ammonia solution of pulp passes through the nozzle, and thus the process efficiency becomes low, whereas when the nozzle diameter is larger than 250 μm, the level of fibrillation may decrease.

The nozzle to be used may be one attached to a homogenizer.

In the present invention, the number of passes through the homogenizer may be in the range from 3 to 20. When the number of passes is less than 3, the level of fibrillation may decrease, whereas when the level of fibrillation is greater than 20, the energy consumption becomes high.

In the present invention, the mean size of the nanofibrillated cellulose prepared after Step 3 may be 100 nm or less.

In an exemplary embodiment of the present invention, it was confirmed that the mean size of nanofibrillated cellulose can be 100 nm or less when homogenization is performed according to the preparation method of nanofibrillated cellulose, namely, homogenization by an aqueous ammonia dispersion instead of an aqueous dispersion (Experimental Example 2 and Experimental Example 4).

### ADVANTAGEOUS EFFECTS OF THE INVENTION

In the method for preparing nanofibrillated cellulose of the present invention, a cellulose aqueous dispersion is homogenized by adding an aqueous alkaline solution and thus ammonia can aid the swell of an amorphous region of cellulose, thereby promoting the nanofibrillation of cellulose during the homogenizing process. Accordingly, the present invention provides a method for preparing high-quality cellulose nanofibrils by a simple process without using the conventional enzymatic treatment.

### BRIEF DESCRIPTION OF DRAWINGS

FIG. 1 shows the results of XRD analysis of cellulose nanofibrils according to the homogenizing process and the kinds of dispersions.

FIG. 2 shows the analysis results of the mean size and the specific surface area of cellulose nanofibrils according to the homogenizing process and the kinds of dispersions.

FIG. 3 shows the analysis results of morphological structures of cellulose nanofibrils according to the homogenizing process and the kinds of dispersions.

FIG. 4 shows the analysis results of the mean size of cellulose nanofibrils according to the amount of addition and the presence of washing.

FIG. 5 shows the analysis results of morphological structures of cellulose nanofibrils according to the homogenizing process and the kinds of dispersions.

FIG. 6 shows the results of XRD analysis of cellulose nanofibrils.

FIG. 7 shows the analysis results of specific surface area of cellulose nanofibrils.

FIG. 8 shows the morphological structures of cellulose nanofibrils.

### DETAILED DESCRIPTION OF THE INVENTION

Hereinafter, the present invention will be described in detail with reference to the following Examples. However, the Examples of the present invention may be embodied in many different forms and these Examples should not be construed as limiting the scope of the present invention.

### EXAMPLE 1

### Nanofibrillation of Cellulose in Aqueous Ammonia Solution

Before being passed through a homogenizer, pulps from hardwoods and softwoods were dispersed in water, respectively, and subjected to a mechanical refining process with the pulper of wet-laid non-woven equipment for 30 minutes, thereby completing dispersion and dissociation. A dispersion with a low solid concentration of 0.2 wt % was prepared and then a 0.3 vol % aqueous ammonia solution was added thereto. The aqueous dispersion and aqueous ammonia dispersion were stirred for 30 minutes, respectively, and passed through the homogenizer. In particular, the internal pressure of the homogenizer was in the range from 70 MPa to 310 MPa and the diameter of the nozzles used was 250 μm, 200 μm, and 150 μm, respectively. The pulp dispersions were sequentially passed 5 times through each nozzles from the nozzle with the largest diameter to nozzle with the smallest diameter in this order for maximizing the fibrillation efficiency of cellulose. The names of samples prepared are shown in Table 1 below.

TABLE 1

| | | | Nozzle Size of Homogenizer⁵⁾-Number of Passes⁶⁾ | | | | | | | | |
|---|---|---|---|---|---|---|---|---|---|---|---|
| Pulp | Dispersion | 0 | 25-1 | 25-3 | 25-5 | 20-1 | 20-3 | 20-5 | 15-1 | 15-3 | 15-5 |
| C¹⁾ | W³⁾ | CW0 | CW | CW | CW | CW | CW | CW | CW | CW | CW |
| | | | 25-1 | 25-3 | 25-5 | 20-1 | 20-3 | 20-5 | 15-1 | 15-3 | 15-5 |
| | A⁴⁾ | CA0 | CA | CA | CA | CA | CA | CA | CA | CA | CA |
| | | | 25-1 | 25-3 | 25-5 | 20-1 | 20-3 | 20-5 | 15-1 | 15-3 | 15-5 |
| I²⁾ | W | IW0 | IW | IW | IW | IW | IW | IW | IW | IW | IW |
| | | | 25-1 | 25-3 | 25-5 | 20-1 | 20-3 | 20-5 | 15-1 | 15-3 | 15-5 |
| | A | IA0 | IA | IA | IA | IA | IA | IA | IA | IA | IA |
| | | | 25-1 | 25-3 | 25-5 | 20-1 | 20-3 | 20-5 | 15-1 | 15-3 | 15-5 |

[Note]
¹⁾Softwood pulp,
²⁾Hardwood pulp,
³⁾water,
⁴⁾aqueous ammonia solution,
⁵⁾nozzle size × 10 μm,
⁶⁾number

### EXPERIMENTAL EXAMPLE 1

### Evaluation of Crystalline Properties of Nanofibrillated Cellulose in Aqueous Ammonia Solution

The crystalline properties of cellulose nanofibrils prepared in Example 1 were evaluated by wide angle X-ray diffraction (XRD), and the crystalline index (CI) was determined by Equation 1 below (L. Y. Mwaikambo et al., Journal of Applied Polymer Science, 2002, 84, 2222-2234).

$$CI = \frac{( {I}_{( 002 )} - {I}_{( am )} )}{{I}_{( 0002 )}} \qquad [ Equation 1 ]$$

The I₍₀₀₂₎ peak, which represents the crystalline region of the cellulose used, and the I₍ₐₘ₎ peak, which represents amorphous region, appeared at 2θ=28° and 16°, respectively.

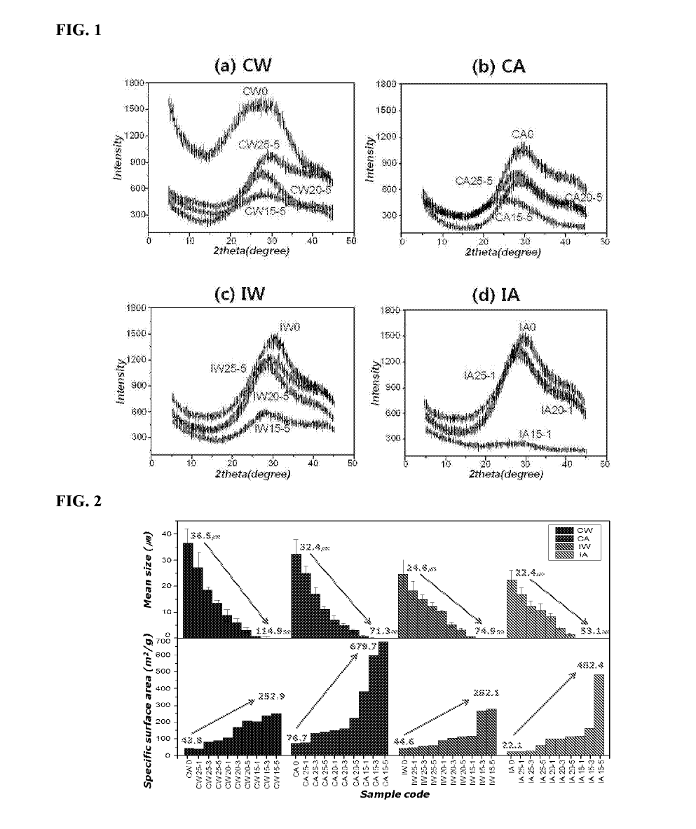

The results of XRD analysis of the cellulose nanofibrils prepared by the above process are illustrated in FIG. 1. From FIG. 1, it was confirmed that, as the number of passes in the homogenizer increased, the 2θ of the crystalline peak moved to small angle and the peak intensity also decreased.

Additionally, XRD peak intensities (of the crystalline region and the amorphous region) and the crystalline index calculated by XRD analysis according to the homogenizing process and dispersions are shown in Table 2 below.

TABLE 2

| | Items | | I₍₀₀₂₎ | I₍ₐₘ₎ | Crystalline Index |
|---|---|---|---|---|---|
| General Pulp¹⁾ | | | — | — | 1.26 to 1.13 |
| | CW | 0 | 1259 | 367 | 0.71 |
| | | 25-1 | 1196 | 379 | 0.68 |
| | | 25-3 | 815 | 261 | 0.68 |
| | | 25-5 | 890 | 290 | 0.67 |
| | | 20-1 | 764 | 270 | 0.65 |
| | | 20-3 | 840 | 346 | 0.59 |
| | | 20-5 | 707 | 335 | 0.53 |
| | | 15-1 | 553 | 273 | 0.51 |
| | | 15-3 | 493 | 274 | 0.44 |
| | | 15-5 | 336 | 230 | 0.32 |
| | CA | 0 | 1047 | 329 | 0.69 |
| | | 25-1 | 820 | 286 | 0.65 |
| | | 25-3 | 906 | 317 | 0.65 |
| | | 25-5 | 888 | 326 | 0.63 |
| | | 20-1 | 775 | 305 | 0.61 |
| | | 20-3 | 704 | 335 | 0.52 |
| | | 20-5 | 568 | 295 | 0.48 |
| | | 15-1 | 443 | 273 | 0.38 |
| | | 15-3 | 499 | 309 | 0.38 |
| | | 15-5 | 263 | 199 | 0.24 |
| | IW | 0 | 1156 | 306 | 0.74 |
| | | 25-1 | 876 | 248 | 0.72 |
| | | 25-3 | 1307 | 442 | 0.66 |
| | | 25-5 | 1028 | 370 | 0.64 |
| | | 20-1 | 653 | 261 | 0.60 |
| | | 20-3 | 692 | 277 | 0.60 |
| | | 20-5 | 611 | 248 | 0.59 |
| | | 15-1 | 533 | 220 | 0.59 |
| | | 15-3 | 520 | 253 | 0.51 |
| | | 15-5 | 425 | 257 | 0.40 |
| | IA | 0 | 1460 | 362 | 0.75 |
| | | 25-1 | 1333 | 332 | 0.75 |
| | | 25-3 | 1340 | 351 | 0.74 |
| | | 25-5 | 1356 | 384 | 0.72 |
| | | 20-1 | 1377 | 391 | 0.72 |
| | | 20-3 | 1294 | 386 | 0.70 |
| | | 20-5 | 1043 | 319 | 0.69 |
| | | 15-1 | 6576 | 2064 | 0.69 |
| | | 15-3 | 1338 | 435 | 0.68 |
| | | 15-5 | 272 | 204 | 0.25 |

[Note]
¹⁾A. E. S. I. Ahmed et al., Pigment & Resin Technology, 2013, 42, 68-78

From Table 2 above, it was confirmed that, while the crystalline index of pulp was generally in the range of 1.26 to 1.13, the crystalline index of pulp mechanically dissociated after dispersing in water or aqueous ammonia solution was in the range of 0.69 to 0.75. In contrast, the crystalline index of cellulose after 15 passes in the homogenizer was decreased to the range of 0.24 to 0.40. These results confirm that the destruction of the crystalline region of the cellulose can be induced by the mechanical dissociation process and the repeated homogenizing process. For the pulp mechanically dissociated after dispersing in aqueous ammonia solution, there was a greater decrease in crystalline index compared to the pulp mechanically dissociated after dispersing in the aqueous dispersion, and this result confirmed that ammonia molecules penetrated into the cellulose molecular chains, caused more effective swelling of the cellulose molecular chains than water molecules, and then helped the fibrillation during the mechanical dissociation and homogenizing process. Additionally, hardwood pulp had a higher crystalline index and a lower decrease in crystalline index caused by the homogenizing process than softwood pulp, and these results appear to be due to intrinsic properties wherein hardwood pulp has a more well-developed crystalline region than softwood pulp.

### EXPERIMENTAL EXAMPLE 2

### Analysis of Specific Surface Area of Nanofibrillated Cellulose in Aqueous Ammonia Solution

The specific surface area (SSA) of cellulose fibrils was analyzed by the Congo red dye adsorption method (M. Ksibi et al., Materials Letters, 2008, 62, 4204-4206). For the calculation of specific surface area, the solutions, prepared by varying the concentration of the Congo red dye at 0.01 mg/mL to 0.16 mg/mL on the phosphate solution (pH 6.0), were treated with 5 mg of cellulose solid, respectively, and dyed in an oven at 50° C. for 24 hours. The as-prepared dispersions were measured for their respective dye adsorption concentration in the UV-VIS wavelength at 500 nm, and the amount of dye adsorption was calculated by Equation 2 below.

$$\frac{1}{A} = ( \frac{1}{{{K}_{ads} [ A ]}_{max}} ) ( \frac{1}{C} ) + ( \frac{1}{{[ A ]}_{max}} ) \qquad [ Equation 2 ]$$

In Equation 2 above, A represents the amount of dye adsorption (amount of dye (mg)/cellulose solid (g)), [A]ₘₐₓ represents the maximum value of dye adsorbed to cellulose (amount of dye (mg)/cellulose solid (g)), C represents the amount of unadsorbed dye (mg/mL), and K_{ads} represents the Langmuir constant.

The specific surface area was calculated by Equation 3 below using the [A]ₘₐₓ calculated by Equation 2 (S. H. Lee, Bioresource Technology, 2010, 101, 769-774).

$${SSA}_{substrate} = {[ A ]}_{max} \times {N}_{A} \times \frac{{SA}_{CR}}{CR} \qquad [ Equation 3 ]$$

In Equation 3 above, N_{A} represents the Avogadro constant (6.022×10²³ mol⁻¹), SA_{CR} represents the surface area of Congo red dye molecules (1.73 nm²), and CR represents the molecular weight of Congo red dye (696.7 g/mol).

In particular, the mean size of cellulose fibrils was analyzed by scanning electron microscope.

The analysis results of the mean size and the specific surface area of the cellulose nanofibrils prepared by the method described above are illustrated in FIG. 2.

The mean size of the cellulose fibrils of hardwood pulp before and after the homogenizing process was shown to be smaller than that of softwood pulp. This result confirms that the hardwood pulp is more effective than softwood pulp in preparing the cellulose nanofibrils by the homogenizing process in aqueous ammonia solution. Additionally, the mean size of the aqueous dispersion of hardwood pulp before the homogenizing process was 24.6 μm, and the mean size of the cellulose fibrils after 15 times of the homogenizing process was decreased to 74.9 nm, whereas the mean size of the cellulose fibrils when aqueous ammonia solution was used was decreased from 22.4 μm to 53.1 nm. From the results, it was confirmed that cellulose nanofibrillation was promoted when aqueous ammonia solution was used as a dispersion compared to when water was used.

Additionally, as the number of passes in the homogenizer increased, the specific surface area of cellulose fibrils increased. In particular, the specific surface area of the sample, which was prepared by dispersing hardwood pulp in aqueous ammonia solution and subjected to the homogenizing process, was most significantly increased from 22.14 m²/g to 482.4 m²/g. This phenomenon showed the same trend as in the decrease of the mean size. As a result, it was confirmed that the mean size of the cellulose fibrils at the micron level was decreased to a nano-size level via the homogenizing process, and the specific surface area finally increased to about 500% to 2,000%. Additionally, it was confirmed that when aqueous ammonia solution was used as the dispersion solution in the homogenizing process, the mean size was further decreased and the specific surface area increased.

### EXPERIMENTAL EXAMPLE 3

### Analysis of Morphological Structures of Nanofibrillated Cellulose in Aqueous Ammonia Solution

The morphological structures of cellulose fibrils were analyzed by a scanning electron microscope.

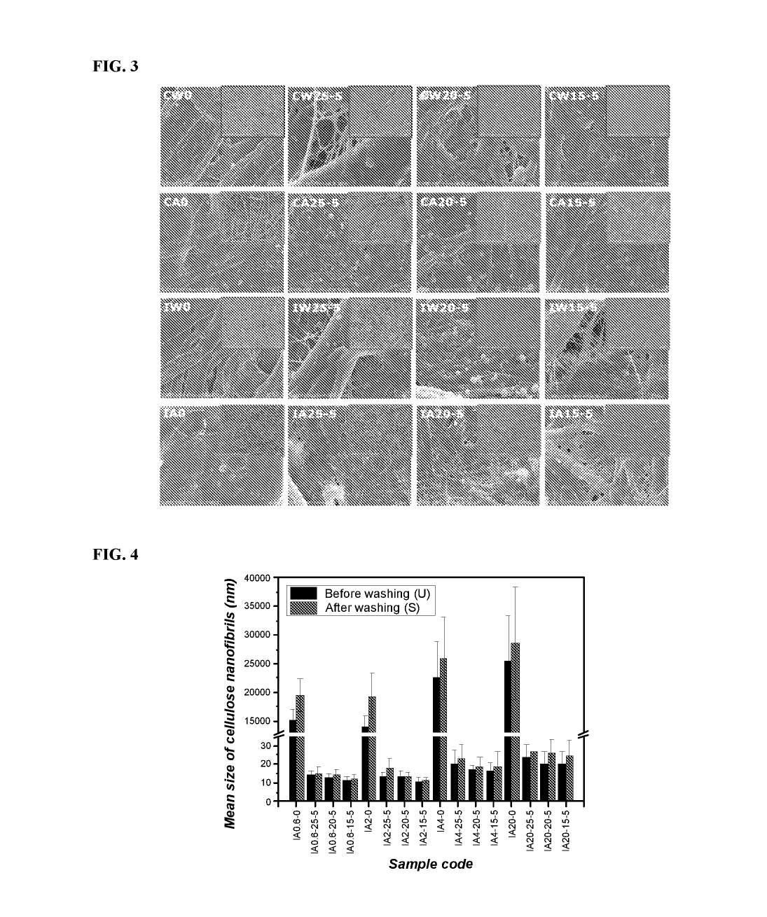

The morphological structures of cellulose fibrils prepared are illustrated in FIG. 3.

From FIG. 3, it was confirmed that as the number of passes in the homogenizer increased, cellulose became more effectively fibrillated in aqueous ammonia solution than in an aqueous dispersion. From the result, it was confirmed that the homogenizing process is more effective for nanofibrillation of hardwood pulp than softwood pulp and that the addition of aqueous ammonia solution improved the nanofibrillation process more rapidly and efficiently.

### EXAMPLE 2

### Nanofibrillation of Cellulose According to the Amount of Aqueous Ammonia Solution Added and the Presence of Washing

In order to examine the effect of the amount of aqueous ammonia solution added and the presence of washing, hardwood pulp was dissociated with pulper according to the mechanical dissociation method of Example 1 and thereby 0.2 wt % aqueous dispersion of pulp was prepared. To an aqueous dispersion of pulp was added aqueous ammonia solution in a vol % of 0, 0.6, 2.0, 4.0, and 20.0, respectively, and each was passed through a homogenizer before and after washing. The internal pressure of the homogenizer, the nozzle diameter, the number of passes, and the experimental method were the same as in Example 1 and the names of the samples prepared are shown in Table 3 below.

TABLE 3

| | | | Added | | | | |
|---|---|---|---|---|---|---|---|
| | | | Amount of | | | | |
| | | Presence of | Ammonia | Nozzle Size in Homogenizer⁶⁾-Number of Passes⁷⁾ | | | |
| Pulp | Dispersion | Washing | (%) | 0 | 25-5 | 20-5 | 15-5 |
| I¹⁾ | W²⁾ | U⁴⁾ | 0 | IWU0 | IWU0-25-5 | IWU0-20-5 | IWU0-15-5 |
| | A³⁾ | U | 0.6 | IAU0.6-0 | IAU0.6-25-5 | IAU0.6-20-5 | IAU0.6-15-5 |
| | | | 2 | IAU2-0 | IAU2-25-5 | IAU2-20-5 | IAU2-15-5 |
| | | | 4 | IAU4-0 | IAU4-25-5 | IAU4-20-5 | IAU4-15-5 |
| | | | 20 | IAU20-0 | IAU20-25-5 | IAU20-20-5 | IAU20-15-5 |
| | | S⁵⁾ | 0.6 | IAS0.6-0 | IAS0.6-25-5 | IAS0.6-20-5 | IAS0.6-15-5 |
| | | | 2 | IAS2-0 | IAS2-25-5 | IAS2-20-5 | IAS2-15-5 |
| | | | 4 | IAS4-0 | IAS4-25-5 | IAS4-20-5 | IAS4-15-5 |
| | | | 20 | IAS20-0 | IAS20-25-5 | IAS20-20-5 | IAS20-15-5 |

[Note]
¹⁾hardwood pulp,
²⁾water,
³⁾aqueous ammonia solution,
⁴⁾no washing,
⁵⁾washing,
⁶⁾nozzle size × 10 μm,
⁷⁾number

### EXPERIMENTAL EXAMPLE 4

### Analysis of the Mean Size of Nanofibrillated Cellulose According to the Amount of Aqueous Ammonia Solution Added and the Presence of Washing

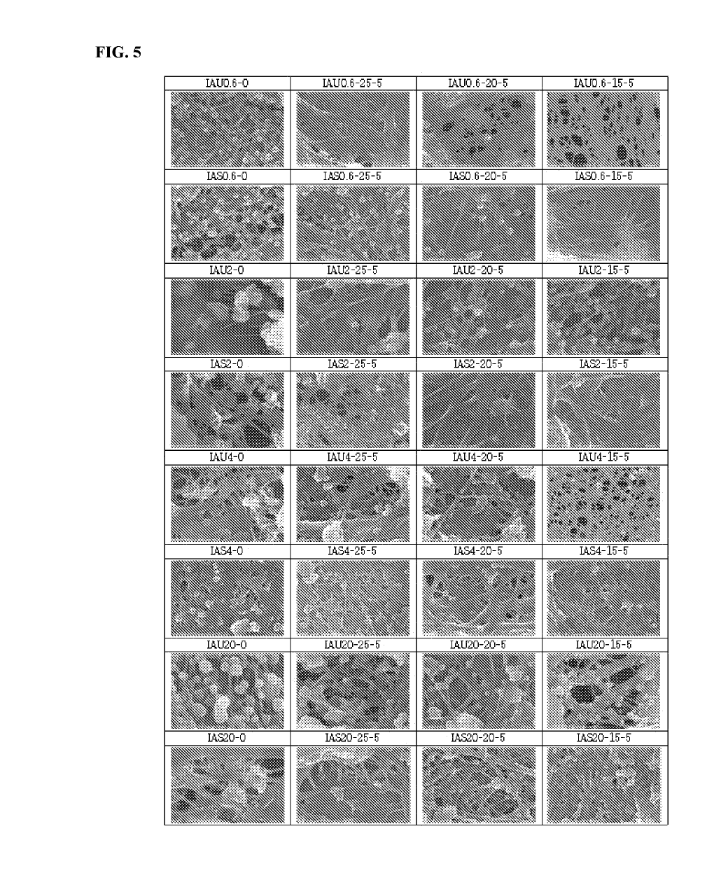

The mean size of the cellulose nanofibrils prepared according to the process in Example 2 was analyzed according to the amount of aqueous ammonia solution added by a scanning electron microscope. The analysis results are illustrated in FIG. 4.

From FIG. 4, it was confirmed that the nanofibrillation of cellulose was promoted and the deviation of mean size became smaller, when aqueous ammonia solution was used as the dispersion solution compared to when an aqueous dispersion was used. Additionally, the most significant decrease of the mean size was shown when cellulose was passed 5 times through a nozzle with a diameter of 250 μm. The cellulose nanofibrils with the smallest mean size were prepared when 2 vol % of aqueous ammonia solution was used as the dispersion solution and washing was not performed, and in this case, the mean size was decreased to the minimum 10 nm level, whereas, on the contrary, the mean size of the cellulose nanofibrils increased when 4 vol % and 20 vol % of aqueous ammonia solution were used, compared to when 0.6 vol % and 2 vol % of aqueous ammonia solution were used, respectively. The results suggest that the excess amount of ammonia added prevented the maintenance of the shape of nanofibrils, thus causing the aggregation of the nanofibrils with the adjacent nanofibrils. It was confirmed that, after the dispersion in ammonia, the unwashed samples had a larger mean size than that of the samples washed before the homogenizing process. Regarding this phenomenon, it is speculated that ammonia molecules effectively swell the space between the cellulose molecular chains under the high pressure and high temperature conditions during the homogenizing process. Accordingly, the cellulose nanofibrils with a small mean size but with uniformity could be obtained when cellulose was subjected to the homogenizing process without washing after the treatment with 2 vol % of ammonia.

### EXPERIMENTAL EXAMPLE 5

### Analysis of Morphological Structures of Nanofibrillated Cellulose According to the Amount of Aqueous Ammonia Solution Added and the Presence of Washing

The morphological structures of the cellulose nanofibrils prepared according to the process in Example 2 were analyzed according to the amount of aqueous ammonia solution added and the presence of washing by a scanning electron microscope. The analysis results are illustrated in FIG. 5.

From FIG. 5, it was confirmed that the mean size of the samples, which were washed before the homogenizing process after the dispersion in aqueous ammonia solution, was slightly larger than that of the samples unwashed before the homogenizing process after the dispersion in aqueous ammonia solution. However, it was confirmed that the washed samples had a smooth surface on the nanofibrils and generated less aggregation, and that as the number of passes in the homogenizer increased, the size of aggregation on the surface of the nanofibrils became smaller. Additionally, the nanofibrillation proceeded more effectively when 0.6 vol % and 2 vol % of aqueous ammonia solution were used, compared to when 4 vol % and 20 vol % of aqueous ammonia solution were used, respectively. Regarding the result, it is speculated that the addition of an excess amount of aqueous ammonia solution prevents the fibrillation of cellulose to the contrary, and causes an aggregation phenomenon wherein the cellulose nanofibrils prepared by the homogenizing process become aggregated with each other. From the result, it was confirmed that the nanofibrillation of cellulose can be promoted by the addition of an appropriately controlled amount of ammonia.

### EXAMPLE 3

### Nanofibrillation of Cellulose in Aqueous Sodium Hydroxide Solution

A 0.2 wt % dispersion based on the weight of the pulp solid was prepared by dispersing hardwood pulp in water and dispersion/dissociation by subjecting the resultant to the mechanical refining process in the same manner as in Example 1. The as-prepared pulp dispersion was treated with 1,000 wt % of 25% aqueous sodium hydroxide solution relative to the weight of the pulp solid, stirred for 30 minutes, and then passed through a homogenizer. The internal pressure of the homogenizer, the diameter of the nozzle used, and the experimental method were the same as in Example 1. The names of the samples used are shown in Table 4 below.

TABLE 4

| | | | Nozzle Size in Homogenizer⁶⁾-Number of Passes⁷⁾ | | | | | | | | |
|---|---|---|---|---|---|---|---|---|---|---|---|
| Pulp | Dispersion | 0 | 25³⁾-1⁴⁾ | 25-3 | 25-5 | 20-1 | 20-3 | 20-5 | 15-1 | 15-3 | 15-5 |
| I¹⁾ | N²⁾ | IN0 | IN | IN | IN | IN | IN | IN | IN | IN | IN |
| | | | 25-1 | 25-3 | 25-5 | 20-1 | 20-3 | 20-5 | 15-1 | 15-3 | 15-5 |

[Note]
¹⁾hardwood pulp,
²⁾aqueous NaOH,
³⁾nozzle size (×10 μm),
⁴⁾number of passes (no.)

### EXPERIMENTAL EXAMPLE 5

### Evaluation of Crystalline Properties of Nanofibrillated Cellulose in Aqueous Sodium Hydroxide Solution

The evaluation of the crystalline properties of the cellulose fibrils prepared by the process of Example 3 was performed in the same manner as in Experimental Example 1.

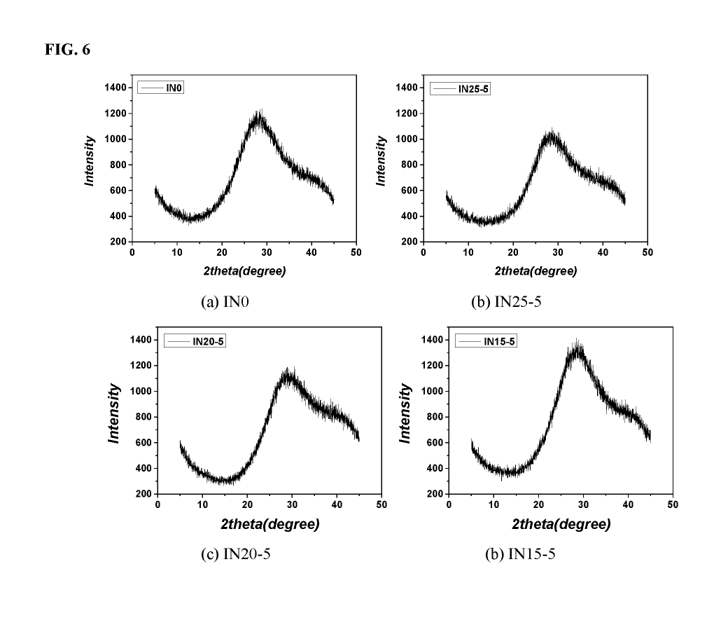

The XRD analysis results of the cellulose nanofibrils prepared by the above process are illustrated in FIG. 6. From FIG. 6, it was confirmed that the 2θ of the crystalline peak moved with a lesser angle as the number of passes in the homogenizer increased.

Additionally, the crystalline index calculated based on the XRD peak intensities (crystalline and amorphous regions) according to the homogenizing process and the use of aqueous sodium hydroxide solution and XRD analysis is shown in Table 5 below.

TABLE 5

| | Items | | I₍₀₀₂₎ | I₍ₐₘ₎ | Crystalline Index |
|---|---|---|---|---|---|
| General Pulp¹⁾ | | | — | — | 1.26 to 1.13 |
| | IN | 0 | 263 | 991 | 0.73 |
| | | 25-5 | 369 | 1341 | 0.72 |
| | | 20-5 | 246 | 734 | 0.66 |
| | | 15-5 | 230 | 519 | 0.56 |

[Note]
¹⁾A. E. S. I. Ahmed et al., Pigment & Resin Technology, 2013, 42, 68-78

From Table 5 above, it was confirmed that, while the crystalline index of general pulp was in the range of 1.26 to 1.13, the crystalline index of pulp mechanically dissociated after dispersing in aqueous sodium hydroxide solution was 0.73, and the crystalline index of cellulose after 15 repetitions of the homogenizing process was decreased to 0.56. These results confirm the destruction of the crystalline region of the cellulose caused by the mechanical dissociation process and the repeated homogenizing process. While the crystalline index of the samples (IW) and (IA), which are prepared by dispersing the same hardwood pulp in water and in aqueous ammonia solution, was decreased to 0.40 and 0.25, respectively, the crystalline index of the sample dispersed in aqueous sodium hydroxide solution was decreased less than the above.

It is speculated that this phenomenon occurs because the aqueous sodium hydroxide solution, which is prepared by dissolving sodium hydroxide in water, remained in a solid phase due to high temperature and high pressure during the homogenizing process and thus could not effectively penetrate into the cellulose molecules, thereby being unable to effectively induce the swelling.

### EXPERIMENTAL EXAMPLE 6

### Analysis of Specific Surface Area of Nanofibrillated Cellulose Prepared in Aqueous Sodium Hydroxide Solution

The specific surface area of the cellulose fibrils prepared in aqueous sodium hydroxide solution was analyzed in the same manner as in Experimental Example 2.

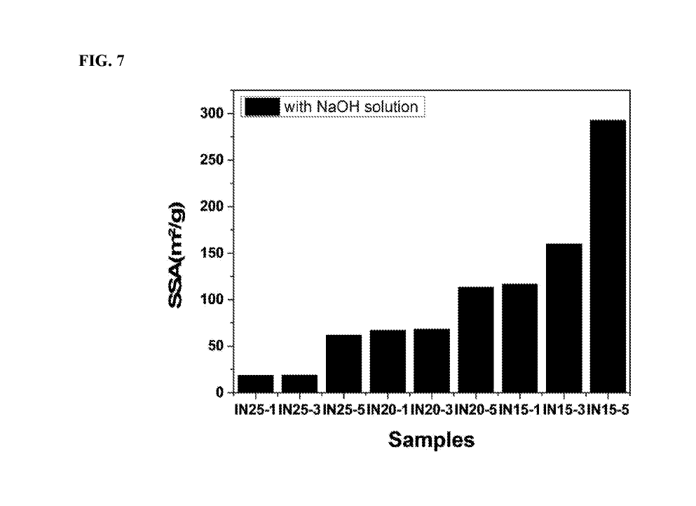

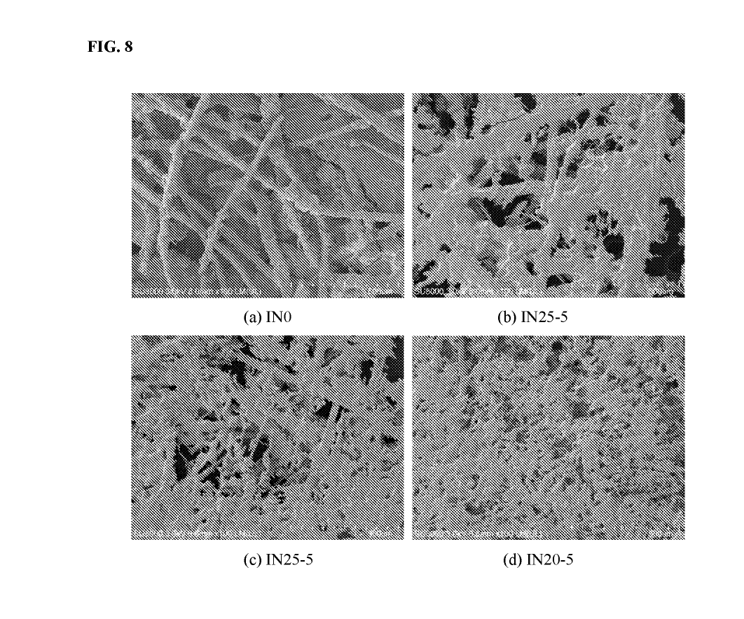

The analysis results of the specific surface area of the cellulose fibrils prepared in aqueous sodium hydroxide solution by the above process are illustrated in FIG. 7.

As the number of passes in the homogenizer increased, the specific surface area of the cellulose fibrils prepared in aqueous sodium hydroxide solution increased. While the specific surface area of the hardwood pulp prepared in aqueous sodium hydroxide solution before the homogenizing process was about 20 m²/g, the specific surface area of the sample after the homogenizing process increased to about 270 m²/g.

The above specific surface area is lower than the values of specific surface area, 282.1 m²/g and 482.4 m²/g, obtained by treating the samples IW and IA, which were prepared by dispersing hardwood pulp in water and aqueous ammonia solution.

Accordingly, it was confirmed that the specific surface area of the nanofibrillated cellulose significantly increased when aqueous ammonia solution was used as a dispersion solution during the homogenizing process, compared to when a water dispersion or aqueous sodium hydroxide solution was used as the dispersion solution.

### EXPERIMENTAL EXAMPLE 7

### Analysis of Morphological Structures of Nanofibrillated Cellulose Prepared in Aqueous Sodium Hydroxide Solution

The morphological structures of cellulose fibrils prepared in aqueous sodium hydroxide solution were analyzed in the same manner as in Experimental Example 3 and the morphological structures of the prepared cellulose fibrils are illustrated in FIG. 8.

From FIG. 8, it was confirmed that although cellulose became fibrillated as the number of passes in the homogenizer increased, the solidified sodium hydroxide remained on the surface of the fibers. From the results of Experimental Examples 3 and 7, it was confirmed that the nanofibrillation process through the homogenizing process could be more rapidly and efficiently improved when the nanofibrillation proceeded in aqueous ammonia solution rather than in water or aqueous sodium hydroxide solution.

1. A method for preparing nanofibrillated cellulose, comprising:
dispersing pulp in water to obtain an aqueous dispersion of pulp (Step 1);
adding an aqueous alkaline solution having a pH between 8 and 14 to the aqueous dispersion of pulp to obtain a dispersed aqueous alkaline solution of pulp (Step 2); and
homogenizing the dispersed aqueous alkaline solution of pulp to obtain a homogenized material (Step 3).

2. The method according to claim 1, further comprising mechanically refining the aqueous dispersion of pulp after Step 1 (Step 1-1).

3. The method according to claim 1, wherein the aqueous alkaline solution having a pH between 8 and 14 is an aqueous ammonia solution.

4. The method according to claim 1, further comprising stirring the dispersed aqueous alkaline solution of pulp after Step 2 (Step 2-1).

5. The method according to claim 1, further comprising drying the homogenized material after Step 3 (Step 3-1).

6. The method according to claim 1, wherein the pulp in Step 1 is a wood pulp.

7. The method according to claim 1, wherein the amount of pulp of the aqueous alkaline solution in Step 2 is from 0.1 vol % to 20 vol % relative to the amount of the dispersed aqueous alkaline solution of pulp.

8. The method according to claim 1, wherein the homogenizing in Step 3 is performed by passing the dispersed aqueous alkaline solution of pulp through a homogenizer.

9. The method according to claim 8, wherein the internal pressure of the homogenizer is in the range from 70 MPa to 310 MPa.

10. The method according to claim 8, wherein the nozzle diameter of the homogenizer is in the range from 50 to 250 μm.

11. The method according to claim 1, wherein the mean size of the nanofibrillated cellulose prepared after Step 3 is 100 nm or less.
